(19) United States
(12) Patent Application Publication
(10) Pub. No.: US 2010/0320273 A1
(43) Pub. Date: Dec. 23, 2010

(54) CODE SYMBOL SCANNING APPARATUS AND CODE SYMBOL SCANNING METHOD

(75) Inventors: Hitoshi Iizaka, Shizuoka (JP); Yoshiya Yamada, Shizuoka (JP); Hidemi Mihara, Shizuoka (JP); Osamu Tsuchiya, Shizuoka (JP); Hidehiro Naito, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/781,038

(22) Filed: May 17, 2010

(30) Foreign Application Priority Data
Jun. 23, 2009 (JP) 2009-148904

(51) Int. Cl. G06K 7/10

(52) U.S. Cl. 235/462.32; 235/470

(57) ABSTRACT

According to one embodiment, a code symbol scanning apparatus includes a line writing unit which overwrites image data scanned by an area image sensor, with a line pattern having a predetermined gradation value, a symbol area designating unit which designates an area of a code symbol that should be scanned from the image edited by the line writing unit, and a code symbol scanning unit which scans the code symbol in the image area designated by the symbol area designating unit.

### CROSS-REFERENCE TO RELATED APPLICATIONS

This application is based upon and claims the benefit of priority from Japanese Patent Application No. 2009-148904, filed Jun. 23, 2009; the entire contents of which are incorporated herein by reference.

### FIELD

Embodiments described herein relate generally to a code symbol scanning apparatus and a code symbol scanning method, for example, a barcode scanner or the like.

### BACKGROUND

As a code symbol scanning apparatus which acquires an image of a code symbol such as a barcode attached to an article and outputs article data, there is an apparatus using an area image sensor such as a CCD image pickup device (charged coupled device image sensor), for example, as disclosed in JP-A-9-62763. In such a code symbol scanning apparatus, image information of a barcode as a target is extracted from image data acquired by the CCD image pickup device and this image information is analyzed to acquire article data.

### BRIEF DESCRIPTION OF THE DRAWINGS

FIG. 1 is a perspective view showing the appearance of a barcode scanner according to a first embodiment;

FIG. 2 shows an example of the configuration of a code symbol scanning apparatus according to the first embodiment;

FIG. 3 shows a control program for the code symbol scanning apparatus according to the first embodiment;

FIG. 4 shows an example of a general barcode according to the first embodiment;

FIG. 5 shows an example of a design barcode according to the first embodiment;

FIG. 6 shows another example of a design barcode according to the first embodiment;

FIG. 7 is a flowchart showing a barcode scanning operation by the code symbol scanning apparatus according to the first embodiment;

FIG. 8 shows an overwrite line pattern (1) in the code symbol scanning apparatus according to the first embodiment;

FIG. 9 shows a design barcode after overwriting according to the first embodiment;

FIG. 10 shows a design barcode after overwriting according to the first embodiment;

FIG. 11 is a flowchart showing a barcode scanning operation by a code symbol scanning apparatus according to a modified example;

FIG. 12 shows an overwrite line pattern (2) in the code symbol scanning apparatus according to the modified example;

FIG. 13 shows an overwrite line pattern (3) in the code symbol scanning apparatus according to the modified example; and

FIG. 14 shows an overwrite line pattern (4) in the code symbol scanning apparatus according to the modified example.

### DETAILED DESCRIPTION

In a code symbol scanning apparatus using an area image sensor, a method of designating a barcode area from image data and decoding the barcode in the designated area may be employed. As the barcode area is sliced out in advance, higher-speed decoding is possible and the decoding probability increases. To slice out the barcode area accurately in advance, a method of utilizing characteristics of the shape shown by the barcode may be employed.

However, recently, design-oriented barcodes (hereinafter referred to as design barcodes) which have different shapes from a conventional barcode shape while guaranteeing the prescriptions for the bar width of the barcode are emerging. The barcode slicing technique targeted at the conventional barcodes cannot cope with such design barcodes and consequently scanning failure may occur in some cases.

Thus, an embodiment of the invention will be described hereinafter with reference to the drawings. In this embodiment, a code symbol scanning apparatus used for a vertical barcode scanner is described as an example of the code symbol scanning apparatus. In this description, common parts are denoted by common reference numerals throughout all the drawings.

In general, according to one embodiment, a code symbol scanning apparatus includes: a line writing unit which overwrites image data scanned by an area image sensor, with a line pattern having a predetermined gradation value; a symbol area designating unit which designates an area of a code symbol that should be scanned from the image edited by the line writing unit; and a code symbol scanning unit which scans the code symbol in the image area designated by the symbol area designating unit.

In general, according to one embodiment, a code symbol scanning method according to an aspect of the invention includes: overwriting image data scanned by an area image sensor, with a line pattern having a predetermined gradation value; designating an area of a code symbol that should be scanned from the image edited by being overwritten with the line pattern; and scanning the code symbol in the designated image area.

### First Embodiment

### 1. Example of Configuration

### 1-1. Example of Outer Configuration of Barcode Scanner

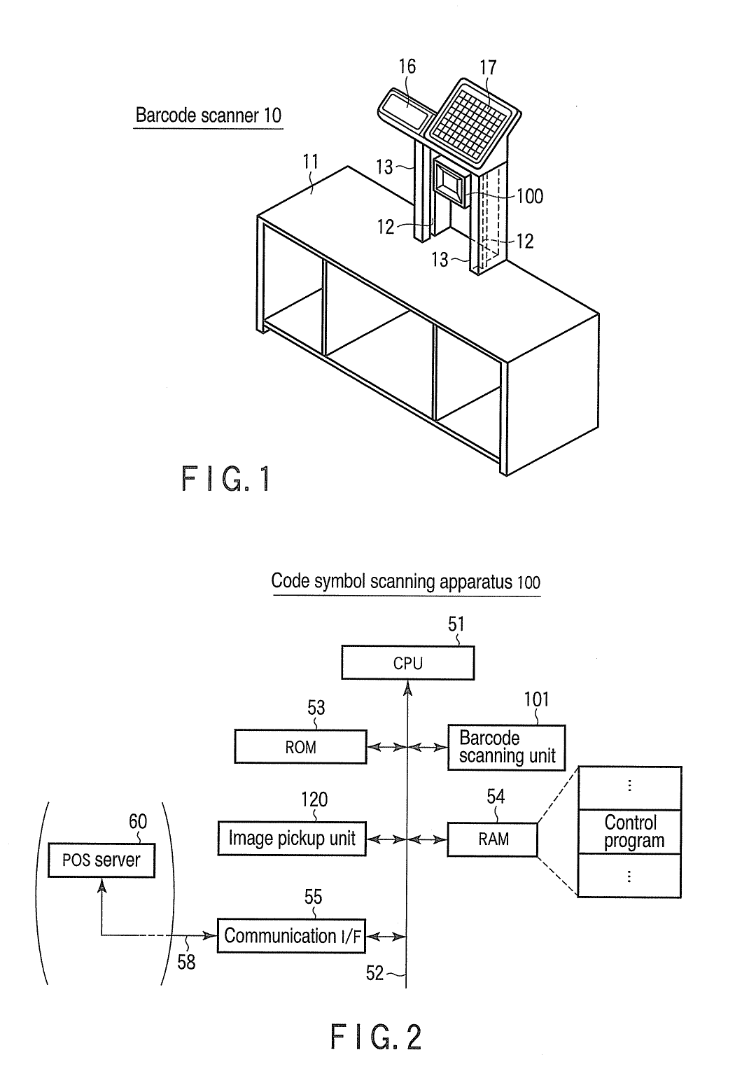

First, an example of the outer configuration of a barcode scanner 10 according to a first embodiment of the invention will be described with reference to FIG. 1.

As shown in FIG. 1, the barcode scanner 10 has a lift function to change the height of a code symbol scanning apparatus 100, thus enabling an operator to carry out scanning more easily. The barcode scanner 10 is arranged upright on a sacker table 11 (or a counter) where a basket or the like having articles put therein is placed.

The barcode scanner 10 is provided with a pair of pillars 13 each having a guide groove 12, and the code symbol scanning apparatus 100 guided to freely rise and fall along the guide grooves 12. In this manner, the code symbol scanning apparatus according to this example is shown as the code symbol scanning apparatus 100 in terms of appearance. A display unit 16 and a keyboard 17 are provided above the code symbol scanning apparatus 100.

In the configuration of the barcode scanner 10 according to this embodiment, the operator places an article in front of the code symbol scanning apparatus 100 and scans a barcode attached to the article. Thus, an output of the code symbol scanning apparatus 100 according to this example is simply barcode scanning information that is scanned.

### 1-2. Example of Configuration of Code Symbol Scanning Apparatus 100

Next, an example of the configuration of the code symbol scanning apparatus 100 will be described with reference to FIG. 2.

As shown in FIG. 2, the code symbol scanning apparatus 100 is equipped with a CPU (central processing unit or control unit) 51 which controls the entire code symbol scanning apparatus 100, as a main control unit. A ROM (read only memory) 53, a RAM (random access memory) 54, a communication interface (I/F) 55, a barcode scanning unit 101, and an image pickup unit 120 are electrically connected to the CPU 51 via a bus 52.

A POS (point of sales) server 60 is connected to the communication interface (I/F) 55 via a LAN (local area network) 58 in a shop.

The POS server 60 has an article database in which, for example, data of the prices and article names of all articles to be sold in the shop is stored in advance. The POS server 60 transmits and receives information about payment processing for articles and records the result of the payment processing for the articles, to and from the code symbol scanning apparatus 100. More specifically, the POS server 60 refers to the article database for decoded data of barcodes attached to articles that is transmitted from the code symbol scanning apparatus 100 via the LAN 58, then reads out data of the prices, article names and the like of the articles corresponding to the decoded data, and sums the prices of all the articles to find payment amount data. The display unit 16, the keyboard (operation input unit) 17, and the code symbol scanning apparatus 100 are connected to the POS server 60 and thus controlled.

In the ROM 53, a control program for the barcode scanning unit 101 may be stored in advance.

In the RAM 54, a work area for storing, for example, images acquired through image pickup by the image pickup unit 120 and decoded data as a result of decoding barcode images, is formed. In a barcode scanning operation (Acts 11 to 18), which will be described later, for example, a control program that is loaded from the ROM 53, the barcode scanning unit 101 or the like and executes the barcode scanning operation (Acts 11 to 18) is temporarily stored in the work area of the RAM 54, as shown in FIG. 2. The barcode scanning operation is executed by the control unit of the CPU 51 or the like.

The image pickup unit 120 outputs a multi-gradation image signal of a picked-up image that is formed on an area image sensor, to the barcode scanning unit 101. The image pickup unit 120 may also be loaded in the barcode scanning unit 101, for example, as a CCD image pickup device.

The barcode scanning unit 101 scans predetermined barcode data from the multi-gradation image signal inputted from the image pickup unit 120, in accordance with the control by the CPU 51, and outputs the scanned barcode data as barcode information to the bus 52. The scanning of barcode data will be described later in detail.

### 1-3. Control Program

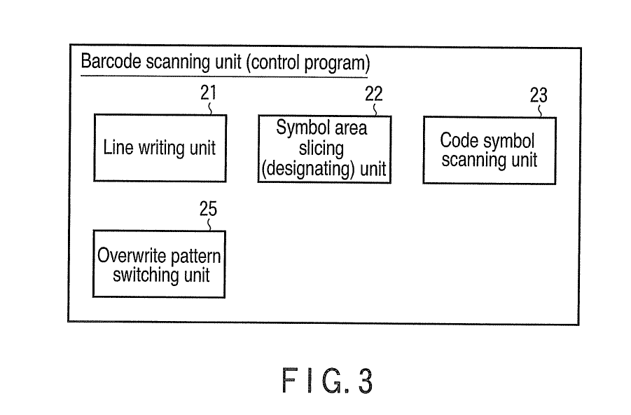

Next, a control program for the code symbol scanning apparatus 100 according to this example will be described with reference to FIG. 3. More specifically, this control program is unfolded in the work area on the RAM 54 and controlled and executed by the CPU (control unit) 51 as described above.

As shown in FIG. 3, the barcode scanning unit 101 according to this example has at least a line writing unit 21, a symbol area slicing unit (symbol area designating unit) 22, a code symbol scanning unit 23, and an overwrite pattern switching unit 25, as the control program.

The line writing unit 21 overwrites the multi-gradation image signal outputted from the image pickup unit 120 with a line pattern having a predetermined gradation value.

The symbol area slicing unit 22 designates (slices out) an area of a code symbol that should be scanned from the image of the multi-gradation image signal edited by the line writing unit 21. More specifically, the symbol area slicing unit 22 designates (slices out) an image signal on the side where independent component bars exist (in this example, an image signal on the lower side), of an image signal separated by a value approximate to the multi-gradation image signal in the space part of the barcode, as shown in FIG. 9 and FIG. 10, which will be referred to later.

The code symbol scanning unit 23 scans the code symbol in the image area outputted from the symbol area slicing unit 22.

The overwrite pattern switching unit 25 switches a line pattern that is used for overwriting by the line writing unit 21, as will be described in detail in a modified example. Further details will be described in the description of the barcode scanning operation.

The control program can be stored in a recording medium that can be read by a computer (information processing apparatus), for example, a floppy disk (trademark registered), optical disk, semiconductor memory or the like. In the stored control program according to this example, a processing content to be carried out by the computer is specified according to the structure of the data recorded in the recording medium.

### 2. Form of Barcode

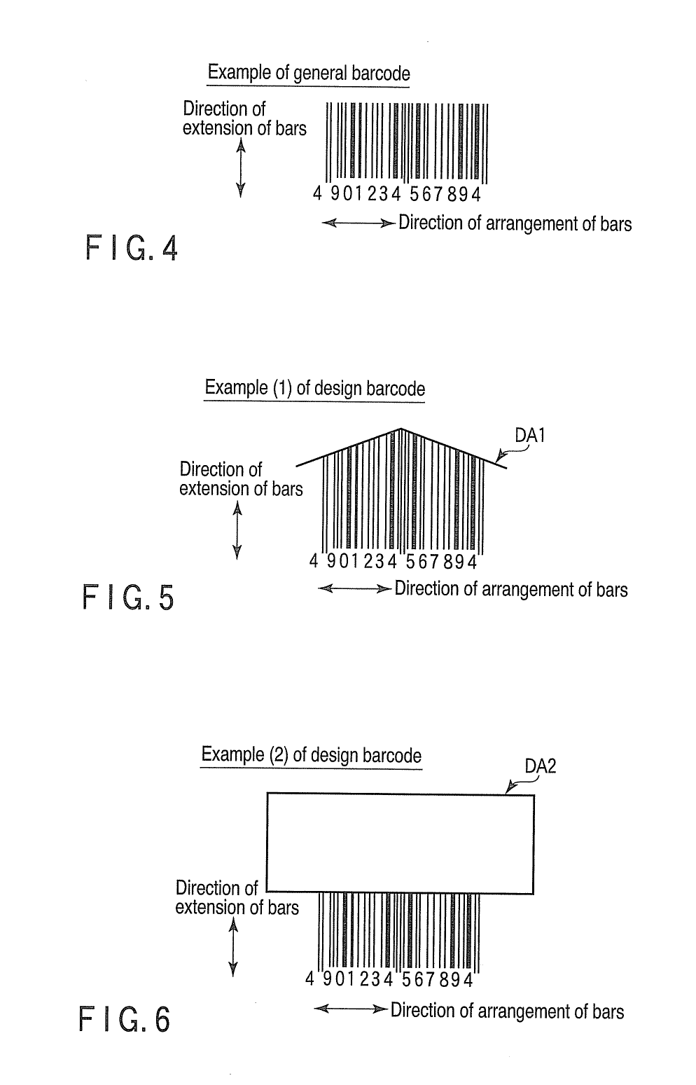

Next, a form of a barcode according to this example will be described with reference to FIG. 4 to FIG. 6.

FIG. 4 shows a form of an exemplary general barcode. As shown in FIG. 4, in this general barcode, each of component bars exist independently and separately from each other. Therefore, a predetermined algorithm (a system for detecting an aggregate of bars having the same length and inclined in the same direction) can function normally. Consequently, a situation where a barcode area cannot be detected (sliced out) does not occur.

Meanwhile, FIG. 5 and FIG. 6 show exemplary forms of exemplary deign barcodes.

In a design barcode (1) shown in FIG. 5, a design DA1 is applied so that one-side ends of component bars are coupled to form an “arrow shape” as a whole. In a design barcode (2) shown in FIG. 6, a design DA2 is applied so that one-side ends of component bars are coupled to form a “rectangular shape”.

Here, even in the design barcodes, the bar width patch of component bars meet prescriptions. Therefore, for example, in the case of a laser-type code symbol scanning apparatus, it can be considered possible to decode these barcodes if scanning on the barcodes can be carried out similarly to the scanning on the general barcode shown in FIG. 4.

However, in the code symbol scanning apparatus using the area image sensor, a barcode area is sliced out from multi-gradation image data outputted from the image pickup unit in order to perform decoding efficiently. In this case, bars forming the barcode are noted as information for detecting the barcode area, and an algorithm to detect an aggregate of bars having the same length and inclined in the same direction is used.

Therefore, in the cases of the design barcodes shown in FIG. 5 and FIG. 6, the one-side ends of component bars contact the lines (DA1 and DA2) for designing, and the individual bars are not independent and separate from each other. Thus, the algorithm (the system of detecting an aggregate of bars having the same length and inclined in the same direction) does not function. Consequently, a situation occurs where the barcode area cannot be detected (sliced out), and scanning failure (in which the code symbol cannot scanned) occurs.

Thus, in the code symbol scanning apparatus according to this example and its code symbol scanning operation, an overwrite line pattern is superimposed on multi-gradation image data outputted from the image pickup unit and the barcode is divided.

Consequently, one area (in the example, the lower side) of the divided barcode can now be detected as a barcode area. Therefore, it is possible to designate (slice out) this area as a barcode area and decode the barcode in the subsequent decoding. Therefore, no scanning failure occurs even with the design barcodes shown in FIG. 5, FIG. 6 or the like.

As for the overwrite line pattern, it is effective to prepare plural line patterns to intersect the direction of extension of the bars. This is because the direction of a barcode as a scanning target cannot be detected in advance. If plural patterns are switched, for example, every frame, the scanning operation can support all directions. Details of this operation will be described later.

### 3. Barcode Scanning Operation

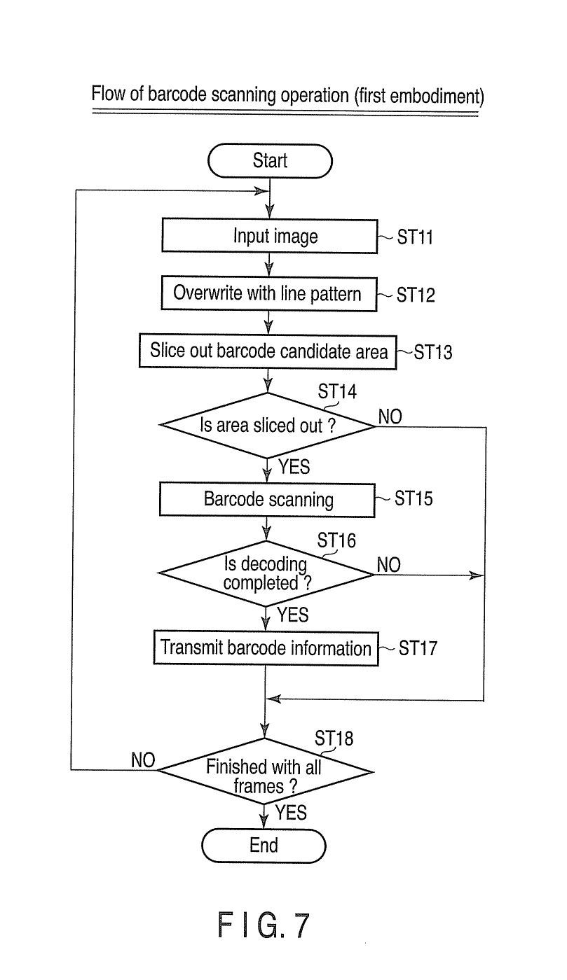

Next, the barcode scanning operation by the code symbol scanning apparatus according to this example will be described with reference to the procedure flow shown in FIG. 7.

### ACT 11

First, the CPU 51 temporarily stores multi-gradation image data picked up by the image pickup unit 120, in the RAM 54.

### ACT 12

Next, the CPU 51 overwrites the multi-gradation image data with a line pattern having a predetermined gradation value. Here, the predetermined gradation value is a value approximate to a multi-gradation image signal in a space part of a barcode. Generally, a gradation value equivalent to a multi-gradation image signal of a white background is set. The inclination angle and position of lines and the number of lines can be set in advance.

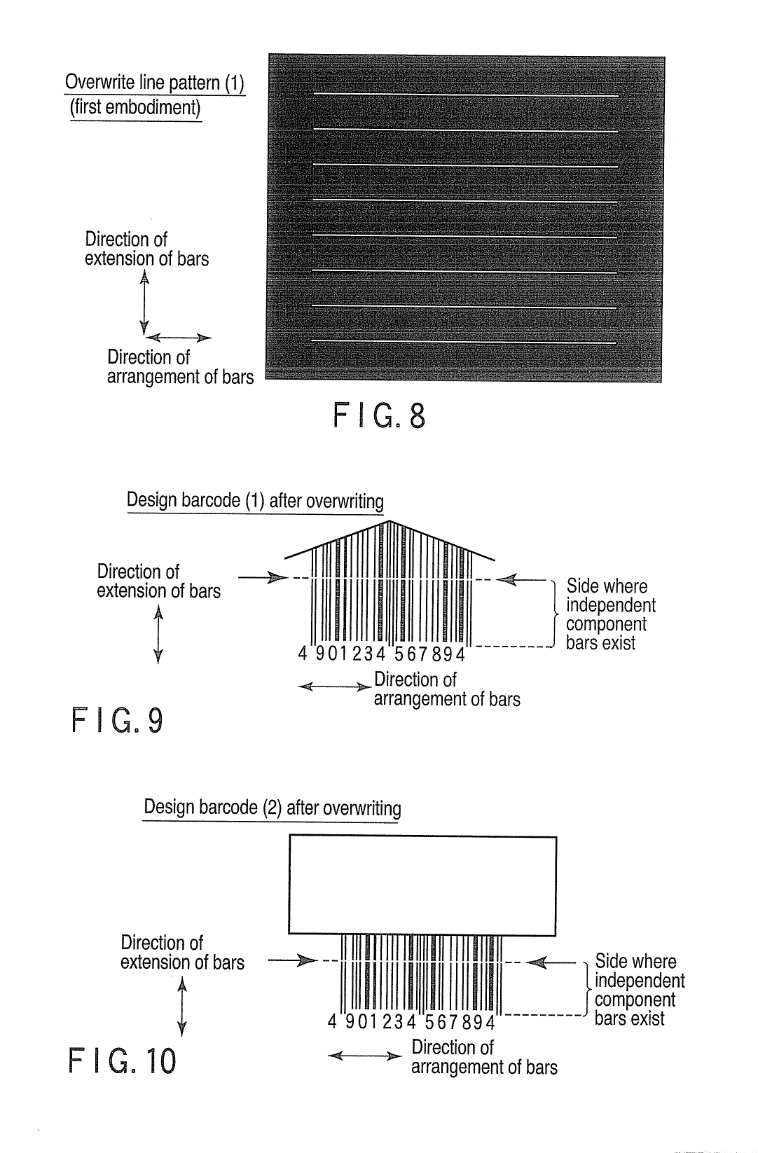

For example, in this example, the line pattern used for overwriting in ACT 12 is a pattern as shown in FIG. 8. An overwrite line pattern (1) shown in FIG. 8 is pattern having plural lines arranged (horizontally as viewed on the sheet surface) to intersect the direction of extension of bars.

The design barcodes, after superimposing the overwrite line pattern (1) shown in FIG. 8 on the multi-gradation image data outputted from the image pickup unit and dividing the image data, appear as shown in, for example, FIG. 9 and FIG. 10.

As indicated by arrows in FIG. 9 and FIG. 10, as a result of superimposing the overwrite line pattern (1) on the multi-gradation image data, the design barcodes (1) and (2) can be vertically divided and then determined in the subsequent ACT 13. One of the divided areas (in this example, the lower side) can be detected as a barcode area. Moreover, in the area that is sliced out and detected as a barcode area, the barcode can be decoded in the subsequent decoding. Therefore, no scanning failure occurs even with the design barcodes (1) and (2) shown in FIG. 5, FIG. 6 and the like.

### ACT 13

Next, a barcode candidate is sliced out of the multi-gradation image thus acquired. In the slicing, for example, the multi-gradation image data is binarized with a predetermined threshold value and an aggregate of areas (assuming individual bars) having the same length and inclined in the same direction is detected.

In this example, the overwrite line pattern (1) is superimposed on the multi-gradation image data in the above ACT 12. Therefore, even in the design barcodes (1) and (2) having bars connected with each other, overwriting with the line pattern enables the barcode area to be sliced out of the area where the barcode is divided.

### ACT 14

Next, the existence of a candidate area that meets a condition is validated. In this case, if there is a candidate area (Yes), the next processing is carried out (ACT 15). On the other hand, if there is no candidate area (No), the processing returns to ACT 11 via the next image input (ACT 18).

### ACT 15

Next, in this barcode scanning processing, decoding is carried out in the barcode candidate area that is sliced out.

### ACT 16

Subsequently, it is determined whether the result of the decoding is completed or not. If the decoding is completed (Yes), the processing goes to the next ACT 17 to send out the result of the decoding (ACT 17). On the other hand, if the decoding is not completed (No), the processing returns to ACT 11 via the next image input (ACT 18).

### ACT 17

Next, the result of the barcode information completed in the decoding is transmitted. In the processing up to this point (ACT 11 to ACT 17), the barcode scanning operation of one frame (one image) is finished.

### ACT 18

Subsequently, it is determined whether barcode scanning is finished with all the frames or not. If barcode scanning is finished with all the frames (Yes), this barcode scanning operation ends (End). Meanwhile, if barcode scanning is not finished with all the frames (No), the processing returns to ACT 11. For example, in the barcode scanning operation in this example, barcode scanning is executed on several to several tens of frames.

### Modified Example

### Example of Switching to Another Overwrite Line Pattern

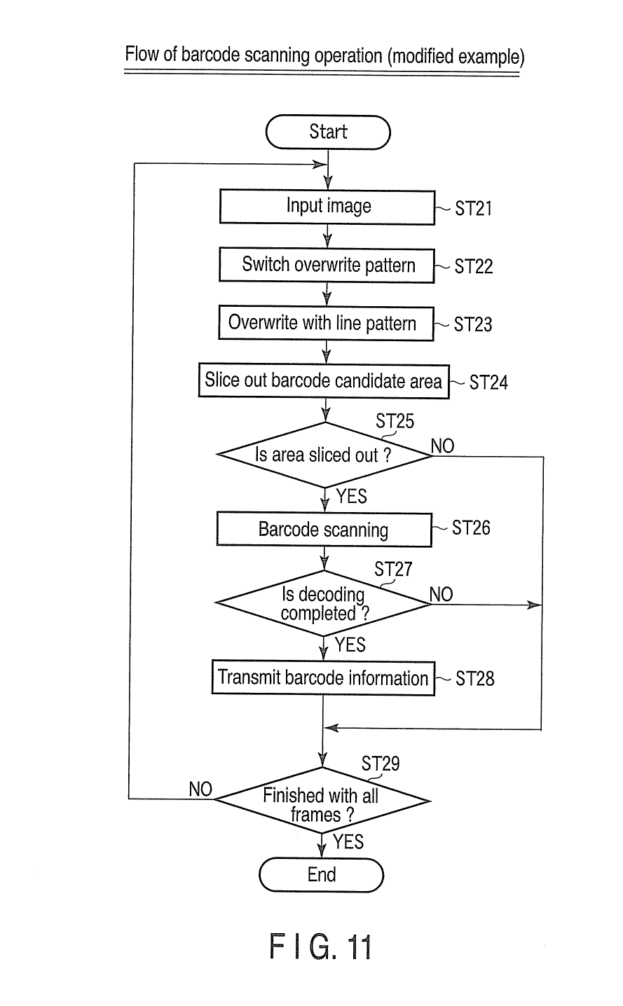

Next, a code symbol scanning apparatus according to a modified example will be described with reference to FIG. 11 to FIG. 14. In this modified example, the overwrite line pattern is switched to another overwrite line pattern. In this description, the same parts as in the first embodiment will not be described further in detail.

### Barcode Scanning Operation

The barcode scanning operation according to this example will be described with reference to FIG. 11.

As shown in FIG. 11, the barcode scanning operation according to this example is different from that of the first embodiment in that ACT 22 is executed additionally.

### ACT 22

After ACT 21, the CPU 51 switches the overwrite line pattern to overwrite the multi-gradation image data.

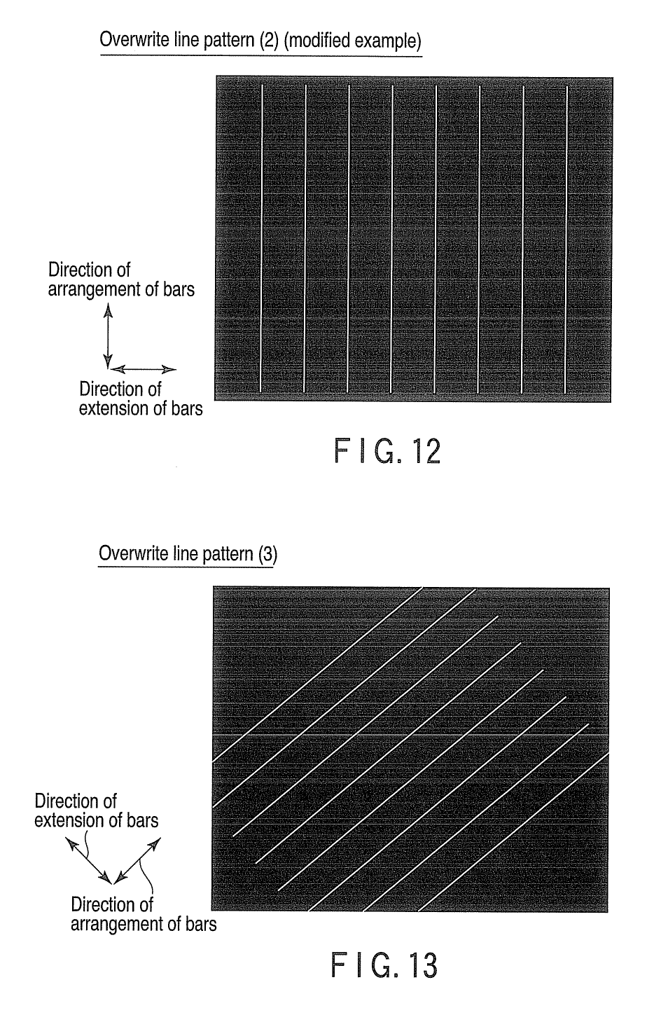

For example, in this example, the CPU 51 switches the overwrite line pattern (1) shown in FIG. 8 to the overwrite line pattern (2) shown in FIG. 12. The overwrite line pattern (2) shown in FIG. 12 to which the switch is made is a pattern having plural lines arranged (vertically as viewed on the sheet surface) to intersect the direction of extension of bars.

After that, the processing of ACT 23 to ACT 29 similar to that of the first embodiment is repeated.

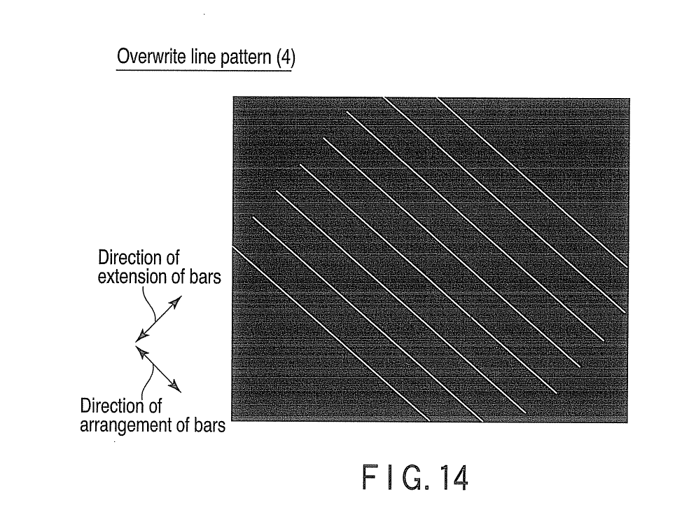

As for the overwrite line pattern to which a switch is made at ACT 22, it is effective to prepare plural line patterns having different directions to intersect the direction of extension of bars. For example, overwrite line patterns (3) and (4) shown in FIG. 13 and FIG. 14 are patterns having plural lines arranged (slantly as viewed on the sheet surface) to intersect the direction of extension of bars. The reason for preparing plural overwrite line patterns in this manner is that the direction of the scanning target barcode cannot be detected in advance at the time of ACT 23 where overwriting with a line pattern is carried out.

The frequency of switching the overwrite line pattern may be every frame or every plural frames according to needs.

As described above, in this example, since plural overwrite line patterns can be switched, scanning can be supported in all directions and a barcode can be sliced out, which is more advantageous in preventing scanning failure.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A code symbol scanning apparatus comprising:
a line writing unit which overwrites image data scanned by an area image sensor, with a line pattern having a predetermined gradation value;
a symbol area designating unit which designates an area of a code symbol that should be scanned from the image edited by the line writing unit; and
a code symbol scanning unit which scans the code symbol in the image area designated by the symbol area designating unit.

2. The apparatus of claim 1, further comprising an image pickup unit which outputs a picked-up image picked up by the area image sensor to the line writing unit as image data of a multi-gradation image signal.

3. The apparatus of claim 1, further comprising a line pattern switching unit which switches a line pattern used for overwriting by the line writing unit.

4. The apparatus of claim 3, wherein the frequency of switching the overwrite line pattern by the line pattern switching unit is every frame or every plural frames.

5. The apparatus of claim 1, wherein the predetermined gradation value is a value approximate to a multi-gradation image signal in a space part of a barcode.

6. The apparatus of claim 1, wherein the pattern used for overwriting by the line writing unit is a pattern having plural lines arranged to intersect a direction of extension of bars.

7. The apparatus of claim 5, wherein the symbol area designating unit designates an image signal on a side where independent component bars exist, of image signals separated by the value approximate to the multi-gradation image signal in the space part of the barcode.

8. The apparatus of claim 1, further comprising a RAM in which a work area for storing at least the image data scanned by area image sensor is formed.

9. The apparatus of claim 1, wherein the apparatus is applied when scanning a code symbol of a design barcode.

10. The apparatus of claim 1, further comprising:
a CPU which controls the apparatus;
a bus which electrically connects at least the line writing unit, the symbol area designating unit and the code symbol scanning unit to the CPU; and
a communication interface which is electrically connected to the bus and communicates with outside.

11. A code symbol scanning method comprising:
overwriting image data scanned by an area image sensor, with a line pattern having a predetermined gradation value;
designating an area of a code symbol that should be scanned from the image edited by being overwritten with the line pattern; and
scanning the code symbol in the designated image area.

12. The method of claim 11, further comprising outputting a picked-up image picked up by the area image sensor as image data of a multi-gradation image signal before overwriting with the line pattern.

13. The method of claim 11, further comprising switching a line pattern used for overwriting.

14. The method of claim 13, wherein the frequency of switching the overwrite line pattern is every frame or every plural frames.

15. The method of claim 11, wherein the predetermined gradation value is a value approximate to a multi-gradation image signal in a space part of a barcode.

16. The method of claim 11, wherein the pattern used for overwriting is a pattern having plural lines arranged to intersect a direction of extension of bars.

17. The method of claim 15, wherein an image signal on a side where independent component bars exist, of image signals separated by the value approximate to the multi-gradation image signal in the space part of the barcode, is designated.
